(19) United States
(12) Patent Application Publication
(10) Pub. No.: US 2024/0389599 A1
(43) Pub. Date: Nov. 28, 2024

(54) Antimicrobial Material Comprising a Tetraalkylphosphonium Ionic Liquid and Metal Nanoparticles

(71) Applicant: University of Windsor, Windsor (CA)

(72) Inventors: John TRANT, LaSalle (CA); Abhinandan BANERJEE, Windsor (CA); Bukola AREMU, Windsor (CA); Sima DEHGHANDOKHT, Windsor (CA)

(21) Appl. No.: 18/672,179

(22) Filed: May 23, 2024

Related U.S. Application Data
(60) Provisional application No. 63/504,227, filed on May 25, 2023.

(51) Int. Cl. A01N 57/34; A01N 59/20; B82Y 40/00

(52) U.S. Cl. CPC A01N 57/34; A01N 59/20; B82Y 40/00

(57) ABSTRACT

An antimicrobial material comprising a tetraalkylphosphonium ionic liquid and metal nanoparticles.

### RELATED APPLICATION

This application claims priority to the 25 May 2023 filing date of U.S. Provisional Patent Application Ser. No. 63/504,227, which is incorporated herein by reference.

### FIELD OF THE INVENTION

This invention relates to antimicrobial materials, and more particularly to the use of a composite material comprising a tetraalkylphosphonium ionic liquid and metal nano- and microparticles as a germicide.

### BACKGROUND OF THE INVENTION

Tetraalkylphosphonium ionic liquids (TAPILS) are a class of poorly packed salts containing [PR₄]⁺ (R=alkyl chains) cations and an inorganic or organic anion. They exist as liquids at, or slightly above, ambient temperatures.

Some tetraalkylphosphonium ionic liquids are known to have an antimicrobial effect. For example, in 2005, Seddon et al. examined the antibacterial action of a variety of tetraalkylphosphonium ionic liquids with the general formula [PR₃R′]X, where R and R′ are alkyl groups and X is an anion such as halide, or typical large non-coordinating ions (“Synthesis, anti-microbial activities and anti-electrostatic properties of phosphonium-based ionic liquids”, Green Chemistry 2005, 7, 855). They found that TAPILs with halide counterions, bearing alkyl chains ranging from pentyl to tetradecyl showed antimicrobial activities, particularly against cocci. This activity was found to be comparable to that of a standard commercial biocide-benzalkonium chloride.

The inventors have identified a limitation of the prior art in that none of the existing studies on tetraalkylphosphonium ionic liquids incorporate a second germicidal entity within the TAPIL matrices to enhance activity.

### SUMMARY OF THE INVENTION

In one aspect the present invention provides an antimicrobial material comprising a tetraalkylphosphonium ionic liquid and metal nanoparticles.

The inventors have surprisingly found that the antimicrobial effects of a tetraalkylphosphonium ionic liquid can be greatly enhanced by the introduction of metal nanoparticles, such as copper. In some embodiments of the invention, this effect has been found to be strongly synergistic, with the overall antimicrobial effect of the material being significantly greater than the sum of the antimicrobial effects of the tetraalkylphosphonium ionic liquid and metal nanoparticles individually.

The inventors have surprisingly found that the antimicrobial effects of at least some embodiments of the present invention are so strong that effective antimicrobial action can be provided even at extremely low concentrations.

The inventors have furthermore surprisingly found that the antimicrobial effects of at least some embodiments of the present invention increase over time, particularly when exposed to oxygen and/or air.

The composite materials in accordance with the invention thus show significant promise for use as novel antimicrobial agents having low cost, high efficacy, and a long storage life.

Further aspects of the invention include the following:

1. An antimicrobial material comprising: a tetraalkylphosphonium ionic liquid; and metal nanoparticles.

2. An antimicrobial material, which optionally includes one or more features of any one or more of the aspects recited above or below, wherein the metal nanoparticles comprise an antimicrobial metal.

3. An antimicrobial material, which optionally includes one or more features of any one or more of the aspects recited above or below, wherein the metal nanoparticles comprise copper.

4. An antimicrobial material, which optionally includes one or more features of any one or more of the aspects recited above or below, wherein the metal nanoparticles comprise silver.

5. An antimicrobial material, which optionally includes one or more features of any one or more of the aspects recited above or below, wherein the tetraalkylphosphonium ionic liquid comprises a halide anion.

6. An antimicrobial material, which optionally includes one or more features of any one or more of the aspects recited above or below, wherein the tetraalkylphosphonium ionic liquid comprises a chloride anion.

7. An antimicrobial material, which optionally includes one or more features of any one or more of the aspects recited above or below, wherein the tetraalkylphosphonium ionic liquid comprises a tetraalkylphosphonium cation having a formula of [PR₁R₂R₃R₄]⁺; wherein R₁, R₂, R₃, and R₄ are each an alkyl group; and wherein R₁ is different from R₂.

8. An antimicrobial material, which optionally includes one or more features of any one or more of the aspects recited above or below, wherein R₁ has one to thirty carbons.

9. An antimicrobial material, which optionally includes one or more features of any one or more of the aspects recited above or below, wherein R₂ has one to thirty carbons.

10. An antimicrobial material, which optionally includes one or more features of any one or more of the aspects recited above or below, wherein R₃ has one to thirty carbons.

11. An antimicrobial material, which optionally includes one or more features of any one or more of the aspects recited above or below, wherein R₄ has one to thirty carbons.

12. An antimicrobial material, which optionally includes one or more features of any one or more of the aspects recited above or below, wherein R₂, R₃, and R₄ are identical.

13. An antimicrobial material, which optionally includes one or more features of any one or more of the aspects recited above or below, wherein R₁ has more carbons than R₂.

14. An antimicrobial material, which optionally includes one or more features of any one or more of the aspects recited above or below, wherein: R₂ is a hexyl group; R₃ is a hexyl group; and R₄ is a hexyl group.

15. An antimicrobial material, which optionally includes one or more features of any one or more of the aspects recited above or below, wherein R₁ is an octyl group.

16. An antimicrobial material, which optionally includes one or more features of any one or more of the aspects recited above or below, wherein R₁ is a tetradecyl group.

17. A composite material, which optionally includes one or more features of any one or more of the aspects recited above or below, comprising: a tetraalkylphosphonium ionic liquid; and copper nanoparticles; wherein the tetraalkylphosphonium ionic liquid comprises a chloride anion and a tetraalkylphosphonium cation having a formula of [PR₁R₂R₃R₄]⁺; wherein: R₁ is an octyl group; R₂ is a hexyl group; R₃ is a hexyl group; and R₄ is a hexyl group.

18. A composite material, which optionally includes one or more features of any one or more of the aspects recited above or below, comprising: a tetraalkylphosphonium ionic liquid; and copper nanoparticles; wherein the tetraalkylphosphonium ionic liquid comprises a chloride anion and a tetraalkylphosphonium cation having a formula of [PR₁R₂R₃R₄]⁺; wherein: R₁ is an tetradecyl group; R₂ is a hexyl group; R₃ is a hexyl group; and R₄ is a hexyl group.

19. A composite material, which optionally includes one or more features of any one or more of the aspects recited above or below, comprising: a tetraalkylphosphonium ionic liquid; and copper nanoparticles.

20. A composite material, which optionally includes one or more features of any one or more of the aspects recited above or below, wherein the tetraalkylphosphonium ionic liquid comprises a halide anion.

21. A composite material, which optionally includes one or more features of any one or more of the aspects recited above or below, wherein the tetraalkylphosphonium ionic liquid comprises a chloride anion.

22. A composite material, which optionally includes one or more features of any one or more of the aspects recited above or below, comprising: a tetraalkylphosphonium ionic liquid; and antimicrobial metal nanoparticles.

23. A composite material, which optionally includes one or more features of any one or more of the aspects recited above or below, wherein the antimicrobial nanoparticles comprise copper.

24. A composite material, which optionally includes one or more features of any one or more of the aspects recited above or below, wherein the antimicrobial nanoparticles comprise silver.

25. A composite material, which optionally includes one or more features of any one or more of the aspects recited above or below, comprising: an antimicrobial tetraalkylphosphonium ionic liquid; and antimicrobial metal nanoparticles.

26. A composite material, which optionally includes one or more features of any one or more of the aspects recited above or below, comprising: a tetraalkylphosphonium ionic liquid; and silver nanoparticles.

27. A composite material, which optionally includes one or more features of any one or more of the aspects recited above or below, wherein the tetraalkylphosphonium ionic liquid comprises a halide anion.

28. A composite material, which optionally includes one or more features of any one or more of the aspects recited above or below, wherein the tetraalkylphosphonium ionic liquid comprises a chloride anion.

29. Use of a composite material as a germicide, which optionally includes one or more features of any one or more of the aspects recited above or below, the composite material comprising: a tetraalkylphosphonium ionic liquid; and metal nanoparticles.

30. Use of a composite material as a germicide, which optionally includes one or more features of any one or more of the aspects recited above or below, wherein the composite material comprises the antimicrobial material or the composite material in accordance with any one or more of the aspects described above or below.

31. A method of killing a microorganism, which optionally includes one or more features of any one or more of the aspects recited above or below, comprising: contacting the microorganism with a composite material, the composite material comprising: a tetraalkylphosphonium ionic liquid; and metal nanoparticles.

32. A method of killing a microorganism, which optionally includes one or more features of any one or more of the aspects recited above or below, wherein the composite material comprises the antimicrobial material or the composite material in accordance with any one or more of the aspects described above or below.

33. A method of reducing microorganisms in an environment, which optionally includes one or more features of any one or more of the aspects recited above or below, comprising: providing a composite material in the environment, the composite material comprising: a tetraalkylphosphonium ionic liquid; and metal nanoparticles.

34. A method of reducing microorganisms in an environment, which optionally includes one or more features of any one or more of the aspects recited above or below, wherein the composite material comprises the antimicrobial material or the composite material in accordance with any one or more of the aspects described above or below.

35. A method of preparing an antimicrobial material, which optionally includes one or more features of any one or more of the aspects recited above or below, comprising: providing a tetraalkylphosphonium ionic liquid; and synthesizing metal nanoparticles within the tetraalkylphosphonium ionic liquid; wherein the antimicrobial material comprises the tetraalkylphosphonium ionic liquid and the metal nanoparticles.

36. A method of preparing an antimicrobial material, which optionally includes one or more features of any one or more of the aspects recited above or below, further comprising: exposing the antimicrobial material to oxygen for at least 24 hours.

37. A method of preparing an antimicrobial material, which optionally includes one or more features of any one or more of the aspects recited above or below, further comprising: exposing the antimicrobial material to oxygen for at least 7 days.

38. A method of preparing an antimicrobial material, which optionally includes one or more features of any one or more of the aspects recited above or below, further comprising: exposing the antimicrobial material to oxygen for at least 5 weeks.

39. A method of preparing an antimicrobial material, which optionally includes one or more features of any one or more of the aspects recited above or below, wherein exposing the antimicrobial material to oxygen comprises exposing the antimicrobial material to air.

40. A method of preparing an antimicrobial material, which optionally includes one or more features of any one or more of the aspects recited above or below, wherein the antimicrobial material comprises the antimicrobial material or the composite material in accordance with any one or more of the aspects described above or below.

### BRIEF DESCRIPTION OF THE DRAWINGS

Further aspects and advantages of the invention will appear from the following description taken together with the accompanying drawings, in which:

FIG. 1 depicts the chemical structures of three tetraalkylphosphonium ionic liquids (TAPILs) studied.

FIG. 2 shows the Minimum Inhibitory Concentration (MIC) and Minimum Bactericidal Concentration (MBC) evaluation of the three TAPILs shown in FIG. 1. The MIC evaluation of the three TAPILs is shown with E. coli (a) and S. aureus (b) as the microorganism under study, using resazurin as an indicator of bacterial viability. The numbers on the right correspond to the TAPILs—i.e. “1” stands for TAPIL-1. The MIC and MBC values (c) are shown for the three TAPILs deployed against E. coli and S. aureus as representative microorganisms.

FIG. 3 shows the absorption spectra of Cu(I)Cl and copper nanoparticles (NPs) in TAPIL-2.

FIG. 4 shows Scanning Electron Microscope (SEM) images of copper nanoparticles in TAPIL-2 (composite-2) at increasingly higher resolutions. In (b), it is possible to make out individual NPs within the clusters.

FIG. 5 shows Transmission Electron Microscope (TEM) images of copper nanoparticles in TAPIL-2. (a) shows HAADF-TEM of TAPIL-2/Cu NPs, showing clusters (inset—Cu NP size distribution profile). (b) shows HR-TEM of the composite material showing Cu NPs.

FIG. 6 shows X-ray Absorption Near Edge Structure (XANES) of the three TAPIL composites immediately upon exposure to air (a), and 24 h of exposure to air (b). Cu(0), Cu(I), and Cu(II) standard spectra are also shown.

FIG. 7 shows the average oxidation state of copper in the three TAPIL composites. The average oxidation state of copper in the ionic liquid sample based on energy shift function is represented graphically for a period of 24 h (a), and tabulated (b).

FIG. 8 shows MIC and MBC of E. coli (a) upon exposure to composite-1 and (2) upon exposure to composite-2, over a time period of 5 weeks.

FIG. 9 shows bacterial panel test results for composite-2.

FIG. 10 shows SEM images of E. coli (a) without exposure to TAPILs or composites; (b) upon exposure to ˜3 μg·mL⁻¹ (sub-MIC) of TAPIL-2; (c) upon exposure to ˜ 65 μg·mL⁻¹ (>MBC) of TAPIL-2; (d) upon exposure to ˜0.1 μg·mL⁻¹ (>MBC) of composite-2. The dashed circles highlight damaged bacterial membranes, while the dashed boxes show thin, shriveled bacterial cells.

### DETAILED DESCRIPTION OF THE DRAWINGS

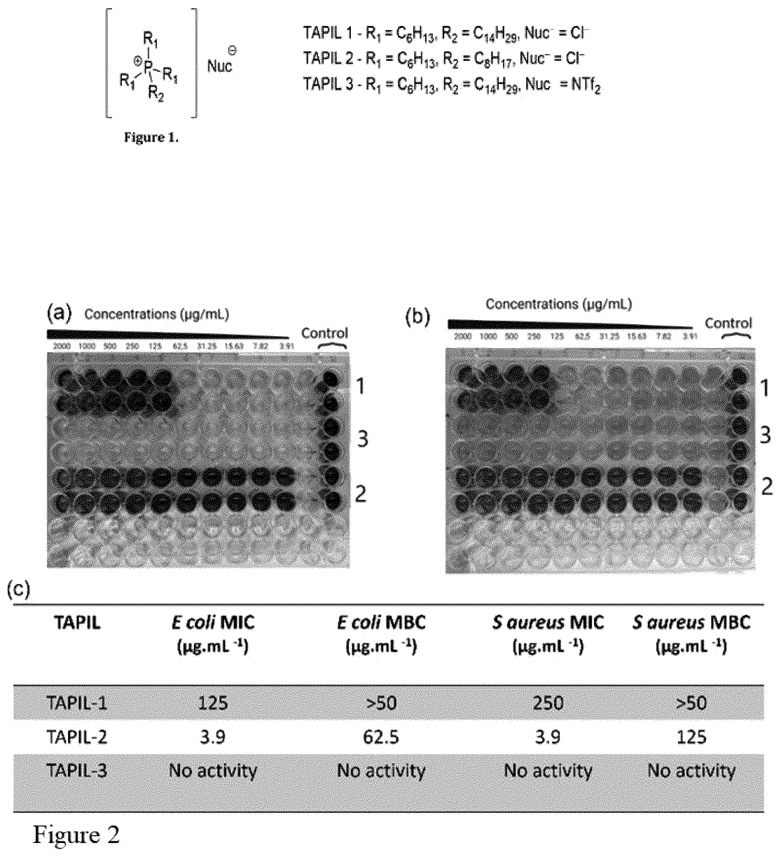

The inventors have conducted a study of three TAPILs (FIG. 1) with varying anti-bacterial effects. The three TAPILs, which were purchased from Strem Chemicals, were dried in a vacuum oven (60° C. for 6-8 hours) and purity confirmed by ¹H and ³¹P NMR to rule out the presence of phosphorous or proton-containing impurities. All three TAPILs are built on a trihexylphosphine base. These alkyl chains are inherently longer than those that have tended to be previously explored by others. They vary by the nature of the fourth group or the nature of the complexing ion. TAPIL1 is the chloride salt of the “long” C-14 chain; TAPIL2 the chloride salt of the “short” C-8 chain; and TAPIL3 the triflimide of the “long” C-14. The chloride ions are hard, nucleophilic, and as co-ordinating as they can be, considering the nature of the cation. The triflimide is a poorly co-ordinating ion for comparison and should result in better charge separation in solution.

These TAPILs were then used as the medium for the synthesis of copper nanoparticles. CuCl was converted to the copper nanoparticles using LiAlH₄. The resulting TAPILs thus contain both copper nanoparticles and Aluminum and Lithium chloride salts. The resulting composites could be stored in the fridge (4° C.) under nitrogen until needed for further studies. The composites do not react with water or the atmosphere, although slow changes were noted in the nature of the copper nanoparticles. The antibacterial potential of both the TAPILs and the dual-modal composite solutions were evaluated.

### Comparison of TAPIL Anti-Bacterial Activities

The three TAPILs were screened against E. coli and S. aureus according to standard procedures (FIG. 2). The bacteria were selected as they are the representative strains (gram negative and positive, respectively) used for European Union regulations in the evaluation of disinfectants. A standard resazurin-based assay was employed: A blue well indicates non-viable bacteria, while a pink one indicates bacterial viability. The MIC and the MBC values are summarized. The data is visually extremely clear: these three TAPILs have widely varying antibacterial properties—N-bis-triflimideTAPIL-3 does not show any anti-bacterial effects even at concentrations as high as 2 mg·mL⁻¹. TAPIL-1 shows bacteriostatic properties at intermediate concentrations, while TAPIL-2 prevents E. coli proliferation at concentrations at least as low as ˜4 μg·mL⁻¹.

These values are in broad accordance with expectations. The length of the alkyl substituents on the TAPIL play an important role in determining the anti-microbial properties of the TAPIL: butyl to octyl cationic groups have been found to be more strongly bacteriocidal, as expressed by low values of MBC. For E. coli, the bacteriostatic and bacteriocidal effects are known to overlap somewhat. TAPIL-2, with three hexyl and one octyl chain, has greater efficacy than TAPIL-1, bearing three hexyl chains and one tetradecyl group. The chloride being more effective is also consistent with the literature as TAPIL-halides are previously reported to have anti-microbial properties. Exchange of the halide for the less coordinating triflimide resulted in the abrogation of the anti-microbial activity of TAPIL-3.

The presence of one longer alkyl chain on the central phosphorus is believed to be preferred for anti-microbial activity since symmetrical TAPILs with four identical alkyl substituents around the phosphorus atom are likely to interact less strongly with the cell membrane to induce cell death. The MIC/MBC values of TAPIL-2 were monitored over a period of 3 weeks upon ambient storage open to the atmosphere. No change in its antimicrobial activity was detected.

### Characterization of TAPIL/Cu NP Composites

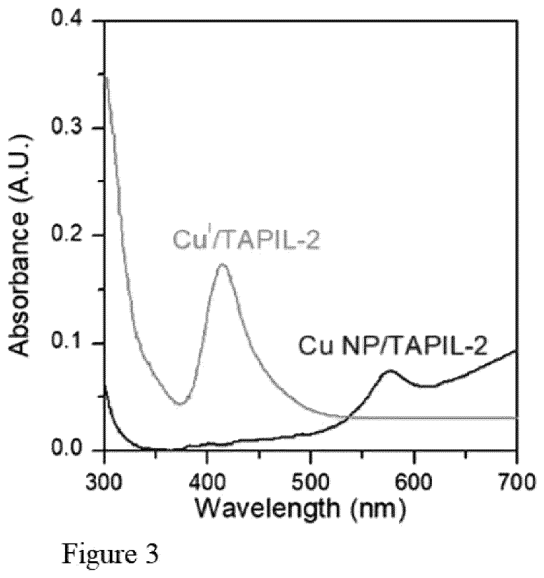

Metallic nanoparticles (NPs) show characteristic UV-visible absorption bands, often indicative of the size, the shape, and the composition of the NPs; these can be compared with CuCl simply suspended in the TAPIL to show conversion (FIG. 3).

CuCl is a white powder that turns TAPIL-2 (clear and colourless) pale yellow upon dissolution. The absorption band for CuCl in TAPIL-2 can consequently likely be attributed to a complex of the type [PR₃R′]⁺ₙ [CuCl₍ₙ₊₁₎]ⁿ⁻.

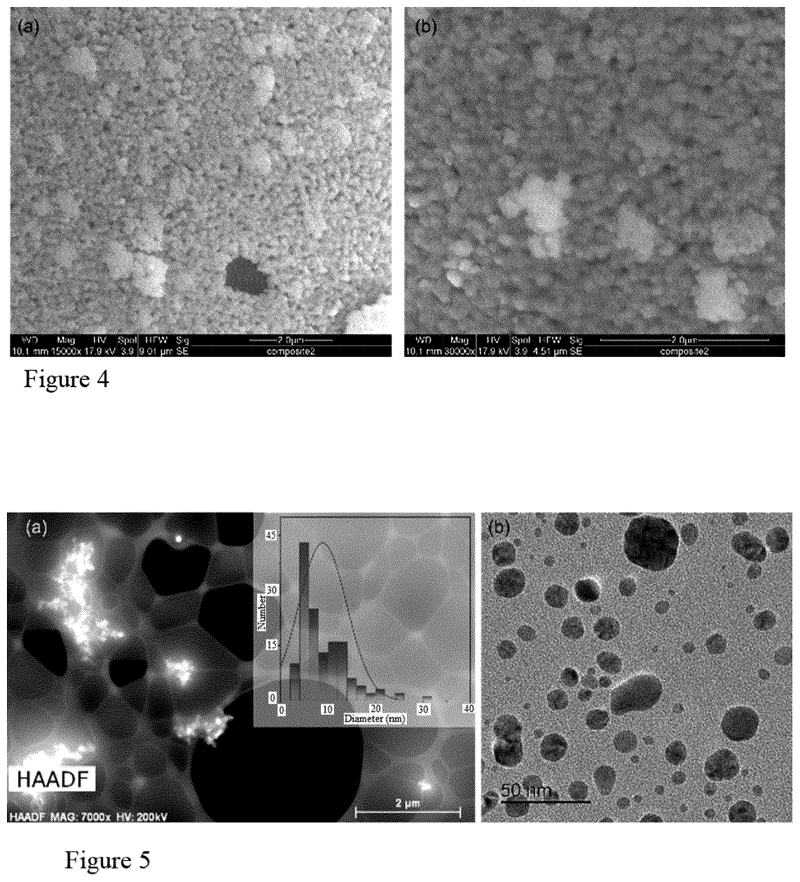

Both Scanning Electron Microscopy (SEM) and Transmission Electron Microscopy TEM (FIG. 4) were used to image the composites, although this was rendered exceptionally difficult by the fact that the TAPIL forms a sticky, protective coating around the NPs. In the SEM images, grape-like clusters of NPs were observed conjoined to each other, rather than isolated NPs suitable for detailed size and shape analysis using high-resolution images.

TEM at higher resolutions, as well as high-angle annular dark-field imaging (HAADF), were used to examine Cu NPs formed within the TAPIL matrices. As FIG. 5(a) reveals, they are still prone to forming clusters, even at high dilutions. From FIG. 5(b), it can be concluded that the Cu NPs are highly polydisperse in terms of size distribution. The average size of the Cu NPs in composite-2 was found to be 9.6±5.2 nm, although some larger aggregates were not taken into consideration while performing the measurements.

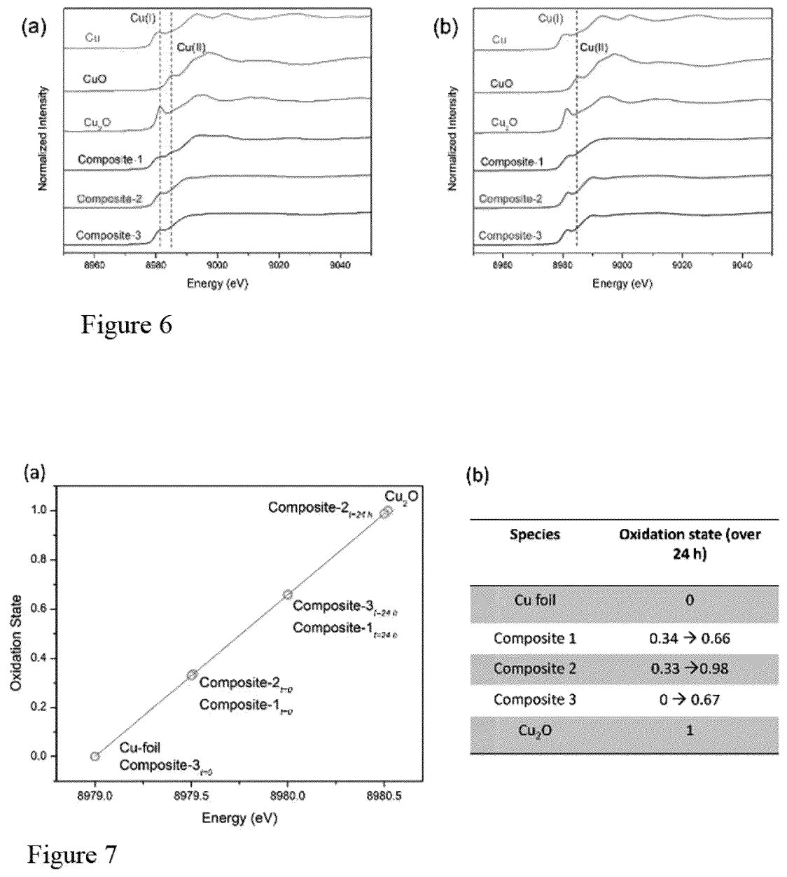

The inventors acquired the normalized Cu K-edge XANES spectra of Cu metal foil, CuO, Cu₂O, and the three composites, either freshly opened, or after 24 h of exposure to air (FIG. 6). Cu foil exhibits a rising-edge transition (4p←1 s) at 8981.0 eV, while this feature is shifted to 8981.5 eV and 8985.5 eV, for Cu(I) oxide and Cu (II) oxide respectively. All three freshly opened composite samples display a similar rising-edge at around 8981 eV, indicating their mixed oxidation state nature [Cu(0) and Cu(I)]. The spectra recorded after 24 h show similar features, but they resemble Cu(I) more closely, indicating slow oxidation of Cu(0) over time to Cu(I), but not to Cu(II), over the period of study.

The inventors then compared the ensemble average oxidation state of copper (δ-Cuₐᵥ) in the composites as a function of copper K-edge energy shift. The oxidation states for Cu within the composites at t=0 are close to, but not exactly, zero. This indicates either in-complete reduction, or that the slow oxidation of Cu(0) to Cu(I) has already begun; after 24 h of exposure to air, the oxidation states increase progressively to values closer to +1. It is noted that the composite containing the N-bis-triflimide anion actually contains almost all its Cu in the zero valent state to begin with, and only shows a small increase at t=24 h. In general, it can be concluded that at t=0, all the composites have oxidation states closer to 0; they then undergo slow oxidation within 24 h, approaching +1 oxidation states. It is not known if the NPs release individual copper ions or small copper clusters over time, since the measured oxidation states are ensemble averages. However, within TAPIL matrices, Cu NPs do “fall apart” over time, releasing charged species that may have catastrophic effects on microorganisms.

### Anti-Bacterial Activities of Composites 1, 2, and 3

The inventors studied the anti-bacterial activities of composites 1 and 2 over time. Composite-3, like the parent TAPIL, did not show any anti-bacterial activity after formation and was eliminated from the tests. Both composite-1 and -2 were bactericidal, with MIC/MBC values in the tens of μg·mL⁻¹ for the former, and in the order of 10⁻² μg·mL⁻¹ for the latter. Thus, composite-2 is a better weapon against E. coli by orders of magnitude in comparison with composite-1.

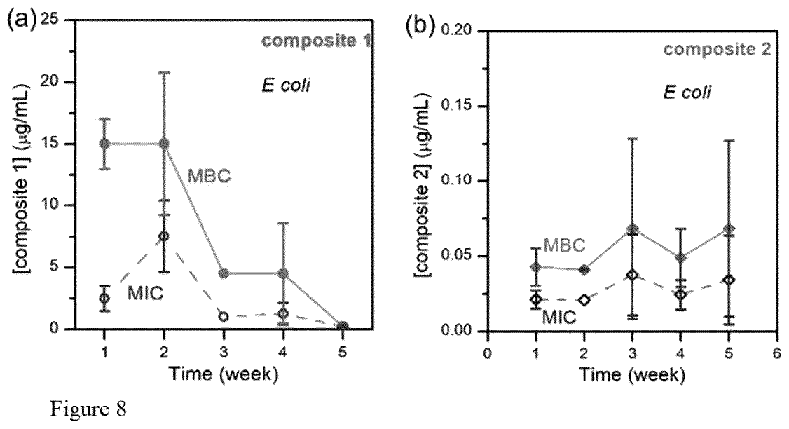

The temporal evolution of the antibacterial activity of the active composites was noteworthy. For many bactericidal materials, the MIC and MBC values increase over time, indicating loss of anti-bacterial activity owing to API degradation over time. In composites 1 and 2, however, there is a downward trend for MIC/MBC values over storage time, especially for composite-1 (FIG. 8). Within the TAPIL-1 and TAPIL-2 matrices, Cu NPs slowly disintegrate over time, releasing charged species (such as Cu(I) ions and/or charged Cu clusters); these charged fragments then annihilate microbes that come into contact with the composites. The longer the material is stored, the greater the exposure to ambient oxygen, and the faster the disintegration of the Cu NPs which serve as reservoirs for copper ions.

Keeping this hypothesis in mind, it is easy to correlate δ-Cuₐᵥ with the antibacterial activities of the composites. In composite-3, δ-Cuₐᵥ=0, and the TAPIL itself possessed no antibacterial properties, so no bactericidal activity was noted for the composite as a whole. Comparing composites 1 and 2, the latter contained the more antimicrobial TAPIL. Composite-2 also showed greater change δ-Cuₐᵥ over 24 h, indicating enhanced release of charged copper species. It is also the most anti-bacterial composite of the three studied. It is believed that the relatively slower oxidation of the Cu NPs in the presence of TAPIL-1 may be related to the fact that it has a longer alkyl chain (C₁₄ as opposed to C₈) which might offer better protection against oxidative decomposition to the Cu NPs enclosed within the TAPILs

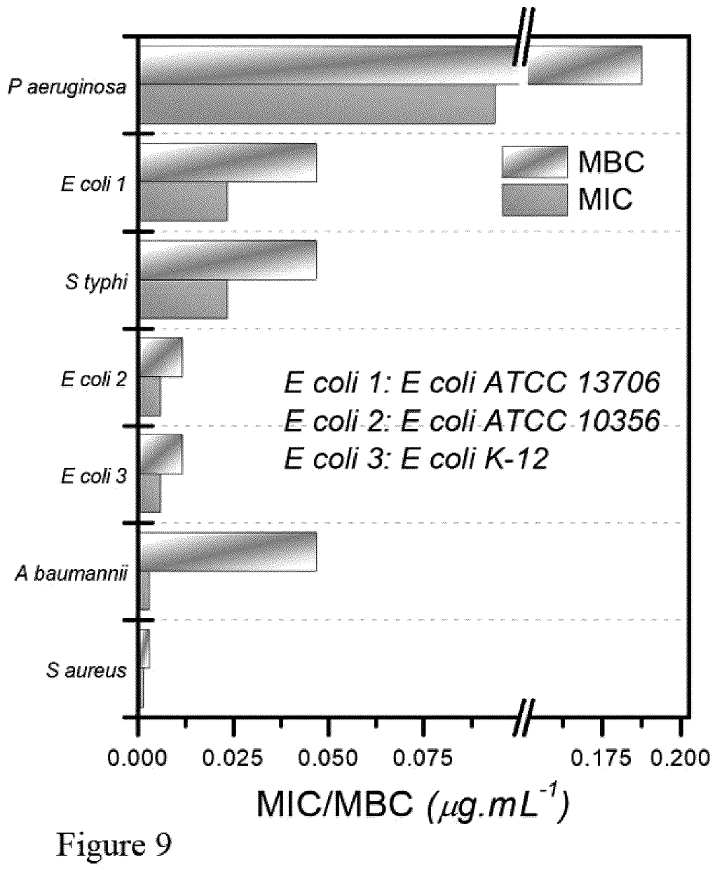

A ‘panel test’ was performed in order to evaluate the antibacterial activity of composite-2 against a number of pathogenic bacteria. The bacteria tested included one Gram positive [Staphylococcus aureus (ATCC 6538)] and six Gram negative [Acinetobacter baumannii (ATCC 19606), Escherichia coli K12 strain (ATCC 10798), Escherichia coli (ATCC 10356), Salmonella enterica subsp. enterica serovar Typhimurium (ATCC 13311), Escherichia coli (ATCC 13706), and Pseudomonas aeruginosa (ATCC 10145)] bacterial species. The results have been depicted in FIG. 9. The order of efficacy of composite-2 in terms of its bactericidal effect varies depending upon the bacterial strain, but for all tested strains, MIC and MBC recorded were of the order of 0.1-0.01 μg·mL⁻¹. The most “resistant” bacteria proved to be P. aeruginosa, an encapsulated, Gram-negative, rod-like bacterium that is known for becoming multidrug resistant. The most susceptible bacterial species was S. aureus, a Gram-positive spherical bacterium. The ratio of MBC/MIC was used to characterize the antimicrobial activity; when the ratio of MBC/MIC≤2, the composite was considered to be bactericidal; for a ratio ≥4, it was defined as being bacteriostatic. Based on the MBC/MIC ratio, composite-2 was designated bacteriostatic for A. baumanii, whereas for all other bacteria, it was bactericidal. In general, ionic liquids are better at destroying Gram-positive bacteria in comparison with Gram-negative bacteria due to the thicker and more lipophilic cell membranes of the Gram-positive bacteria, whereas Cu NPs are known to be effective against both types of bacteria.

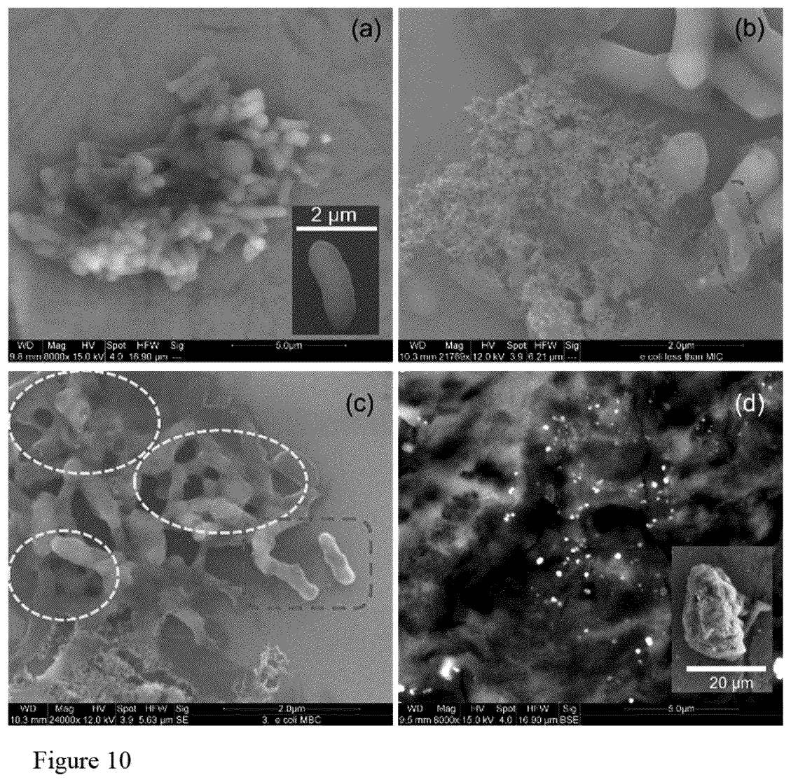

The inventors designed additional SEM experiments to observe the effect of exposure of E. coli to the TAPILs, as well as to the composites created from the TAPILs. The SEM images are shown in FIG. 10.

The proposed mechanism of action of the composites involves the copper ions released from Cu NPs absorbing onto the bacterial cell surface, damaging the cell membrane, hampering their replication process, with inducing cell death. Redox reaction cycles involving Cu (0), Cu(I), and Cu(II) have been known to occur on the surface of bacterial cells. This produces peroxides, which are known to compromise the cytoplasmic membrane. It is expected that composites 1 and 2 show significant redox activity, so this pathway is likely active. Copper ions also impact the permeability of the cell membrane, leading to cellular damage. The inventors have demonstrated that composites 1 and 2 release copper ions, especially upon exposure to ambient air. From these results, it is believed that binding of copper ions to the bacterial cell surface plays an important role in bactericidal activity of the composites. However, this activity does not take place in a vacuum, but is occurring in a cell-penetrating ionic liquid.

The major pathway for bacterial damage induced by ionic liquids include: (i) sorption onto the cell surface; (ii) deactivation of bacterial membrane proteins and electrostatic interaction of the ionic liquid molecule with membrane phospholipids; and finally (iii) cell penetration, formation of physical pores, leakage of intracellular cytoplasm, and cell lysis. This process can be followed through imaging.

SEM micrographs of untreated E. coli show clusters of rod-shaped cells with relatively smooth surfaces, indicating the integrity of the bacterial membrane (FIG. 10a). After 18-24 h of incubation with TAPIL-2 at concentrations slightly below MIC, the cells seem to lose their membrane integrity, with some visible cavities in the cell walls. Meanwhile, some of the cells in FIGS. 10b and 10c present numerous tears or ruptures in their cell walls. This is likely due to the TAPILs irreversibly compromising bacterial cell membrane permeability and creating pores. The rupture of the cellular membrane can lead to leakage of essential solutes, thus producing a shriveled, indented appearance of E. coli cells, which have been highlighted in broken red boxes in FIGS. 10b and 10c. Furthermore, collapsed E. coli cells can be seen in FIG. 10b, spilling cellular debris.

The most catastrophic effects on E. coli cells were noticed, however, upon exposure of the cells to composite-2, at a concentration slightly above the MBC. Cells were totally annihilated, and no surviving E. coli cells were found despite repeated attempts at imaging; only spilled cellular material could be seen. The Cu NPs within the composites showed up as bright dots amidst the bacterial detritus. These results seem to indicate that direct damage to the cytoplasmic membrane of the E. coli cells, owing to strong interactions between the membrane and the composites, elicits cell death.

It will be understood that, although various features of the invention have been described with respect to one or another of the embodiments of the invention, the various features and embodiments of the invention may be combined or used in conjunction with other features and embodiments of the invention as described and illustrated herein.

The inventors have discovered that novel antimicrobial materials having unique and advantageous properties can be produced by combining a tetraalkylphosphonium ionic liquid and metal nanoparticles. A person skilled in the art on reading this disclosure will appreciate that the invention is not limited to the particular examples that have been described. Rather, the scope of the invention as described herein includes all variations that a person skilled in the art, having regard to this disclosure, would now reasonably expect to produce useful antimicrobial materials.

For example, a person skilled in the art would appreciate that the copper nanoparticles described in the examples could be replaced with nanoparticles of other metals known to have an antimicrobial effect, such as silver. Any suitable metal or combination of metals/alloys known or expected to have an antimicrobial effect could be selected.

Similarly, a person skilled in the art would appreciate that the tetraalkylphosphonium ionic liquid anion need not be chloride. For example, a person skilled in the art would understand that other halide anions, such as fluoride or bromide, could also be selected. Any suitable anion that is known or expected to result in a tetraalkylphosphonium ionic liquid with antimicrobial properties could be selected.

Furthermore, the tetraalkylphosphonium cation is not limited to the particular cations described in the examples. For example, a person skilled in the art will appreciate that the lengths of the alkyl chains could be varied to include additional carbons or fewer carbons than those described in the examples. Any suitable tetraalkylphosphonium cation known or expected to result in a tetraalkylphosphonium ionic liquid with antimicrobial properties could be selected. Moreover, diphosphonium cations of the type shown below could also be used.

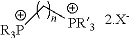

Although the preferred embodiments of the invention as described herein have been described as having various unique properties and advantages, it is to be understood that the invention is not limited to embodiments having properties and advantages that are identical to those provided by the examples.

As used herein, the term “nanoparticle” refers to a particle between 1 and 10,000 nm (i.e. up to 10 um).

Although this disclosure has described and illustrated certain preferred embodiments of the invention, it is to be understood that the invention is not restricted to these particular embodiments. Rather, the invention includes all embodiments which are functional or chemical equivalents of the specific embodiments and features that have been described and illustrated herein.

We claim:

1. An antimicrobial material comprising:
a tetraalkylphosphonium ionic liquid; and
metal nanoparticles.

2. The antimicrobial material according to claim 1, wherein the metal nanoparticles comprise an antimicrobial metal.

3. The antimicrobial material according to claim 1, wherein the metal nanoparticles comprise copper.

4. The antimicrobial material according to claim 1, wherein the metal nanoparticles comprise silver.

5. The antimicrobial material according to claim 1, wherein the tetraalkylphosphonium ionic liquid comprises a halide anion.

6. The antimicrobial material according to claim 1, wherein the tetraalkylphosphonium ionic liquid comprises a chloride anion.

7. The antimicrobial material according to claim 1, wherein the tetraalkylphosphonium ionic liquid comprises a tetraalkylphosphonium cation having a formula of [PR₁R₂R₃R₄]⁺;
wherein R₁, R₂, R₃, and R₄ are each an alkyl group; and
wherein R₁ is different from R₂.

8. The antimicrobial material according to claim 7, wherein R₁ has one to thirty carbons;
wherein R₂ has one to thirty carbons;
wherein R₃ has one to thirty carbons; and
wherein R₄ has one to thirty carbons.

9. The antimicrobial material according to claim 7, wherein R₂, R₃, and R₄ are identical.

10. The antimicrobial material according to claim 9, wherein R₁ has more carbons than R₂.

11. The antimicrobial material according to claim 7, wherein:
R₂ is a hexyl group;
R₃ is a hexyl group; and
R₄ is a hexyl group.

12. The antimicrobial material according to claim 7, wherein R₁ is an octyl group.

13. The antimicrobial material according to claim 7, wherein R₁ is a tetradecyl group.

14. A composite material comprising:
a tetraalkylphosphonium ionic liquid; and
copper nanoparticles.

15. The composite material according to claim 14, wherein the tetraalkylphosphonium ionic liquid comprises a halide anion.

16. The composite material according to claim 14, wherein the tetraalkylphosphonium ionic liquid comprises a chloride anion.

17. The composite material according to claim 16, wherein the tetraalkylphosphonium ionic liquid comprises a tetraalkylphosphonium cation having a formula of [PR₁R₂R₃R₄]⁺;
wherein:
R₁ is an octyl group;
R₂ is a hexyl group;
R₃ is a hexyl group; and
R₄ is a hexyl group.

18. The composite material according to claim 16, wherein the tetraalkylphosphonium ionic liquid comprises a tetraalkylphosphonium cation having a formula of [PR₁R₂R₃R₄]⁺;
wherein:
R₁ is an tetradecyl group;
R₂ is a hexyl group;
R₃ is a hexyl group; and
R₄ is a hexyl group.

19. A composite material comprising:
an antimicrobial tetraalkylphosphonium ionic liquid; and
antimicrobial metal nanoparticles.

20. The composite material according to claim 19, wherein the antimicrobial metal nanoparticles comprise at least one of: copper and silver.
